(19) United States
(12) Patent Application Publication
(10) Pub. No.: US 2003/0200222 A1
(43) Pub. Date: Oct. 23, 2003

(54) File Storage system having separation of components

(76) Inventors: George Feinberg, Windham, ME (US); Olaf W. Manczak, Hayward, CA (US); Kacper Nowicki, Hayward, CA (US); Waheed Qureshi, Danville, CA (US); Luis Ramos, Glendale, CA (US)

Correspondence Address: Barry N. Young, Gray Cary Ware & Freidenrich, 1755 Embarcadero Road, Palo Alto, CA, 94303, US

(21) Appl. No.: 10/442,528

(22) Filed: May 20, 2003

Related U.S. Application Data
(63) Continuation of application No. 09/664,677, filed on Sep. 19, 2000.

(51) Int. Cl. G06F 7/00

(52) U.S. Cl. 707/100

(57) ABSTRACT

According to one embodiment, a storage system (100) may include an interface component (106) having a number of gateway servers (114), a metadata service component (108) having a number of metadata servers (116), and a content service component (110) that includes a number of storage servers (118). Scalability may be improved by enabling servers to be added to each different component (106, 108 and 110) separately. Availability may be improved as software and/or hardware can be changed for host machine in a component (106, 108 and 110) while the remaining host machines of the component continue to function.

### TECHNICAL FIELD

The present invention relates generally to computing systems, and more particularly to a method and apparatus for storing files on a distributed Computing System.

### BACKGROUND OF THE INVENTION

Increasingly, enterprises and co-location hosting facilities rely on the gathering and interpretation of large amounts of information. According to particular applications, file storage systems may have various needs, including scalability, availability, and flexibility.

Scalability can include the ability to expand the capabilities of a storage system. For example, it may be desirable to increase the amount of files that can be stored in a system. As another example, it may be desirable to increase the speed at which files may be accessed and/or the number of users that may simultaneously access stored files.

Availability can include the ability of a system to service file access requests over time. Particular circumstances or events can limit availability. Such circumstances may include system failures, maintenance, and system upgrades (in equipment and/or software), to name but a few.

Flexibility in a storage system can include how a storage system can meet changing needs. As but a few examples, how a system is accessed may change over time, or may vary according to particular user type, or type of file accessed. Still further, flexibility can include how a system can accommodate changes in equipment and/or software. In particular, a storage system may include one or more servers resident on a host machine. It may be desirable to incorporate improvements in host machine equipment and/or server processes as they are developed.

A typical storage system may be conceptualized as including three components: interfaces, metadata and content (files). Interfaces can allow the various stored files to be accessed. Metadata can include information for stored files, including how such files are arranged (e.g., a file system). Content may include the actual files that are stored.

In most cases, interface, metadata and content are arranged together, both logically and physically. In a monolithic server approach, a single computing machine may include all storage system components. An interface for servicing requests from users may include a physical layer for communicating with users, as well as one or more processes for receiving user requests. The same, or additional processes, may then access metadata and/or content according to such requests. Metadata and content are typically stored on the same media of the monolithic server.

Storage systems may also be distributed. That is, the various functions of a storage system may be separate logically and physically. Most conventional distributed storage systems separate an interface from metadata and storage. However, metadata and storage remain essentially together. Two examples of conventional distributed storage systems will now be described.

Referring now to FIG. 6A, a block diagram of one example of a conventional storage system is shown. In FIG. 6A, client machines 600-0 to 600-n may be connected to a number of file server machines 602-0 to 602-n by a communication network 604. In the arrangement of FIG. 6A, client machines (600-0 to 600-n) can be conceptualized as including an interface of a storage system while file server machines (602-0 to 602-n) may be conceptualized as including metadata and content for a storage system. In this way, a conventional approach may physically separate an interface from metadata and content. However, content and metadata remain closely coupled to one another.

It is understood that in this, and all following description, a value n may be a number greater than one. Further, the value n for different sets of components does not necessarily mean that the values of n are the same. For example, in FIG. 6, the number of client machines is not necessarily equal to the number of file server machines.

Client machines (600-0 to 600-n) may include client processes (606-0 to 606-n) that can generate requests to a file system. Such requests may be processed by client interfaces 608-0 to 608-n, which can communicate with file server machines (602-0 to 602-n) to complete requests.

Each file server machine (602-0 to 602-n) may include server interfaces (610-0 to 610-n) that can receive requests from clients. In addition, each file server machine (602-0 to 602-n) can run one or more server processes (612-0 to 612-n) that may service requests indicated by server interfaces (610-0 to 610-n). A server process (612-0 to 612-n) can access data accessible by a respective file server machine (602-0 to 602-n).

In the example of FIG. 6A, a file server machine (602-0 to 602-n) may have a physical connection to one or more data storage devices. Such data storage devices may store files (614-0 to 614-n) and metadata corresponding to the files (616-0 to 616-n). That is, the metadata 616-0 of file server machine 602-0 can correspond to the files 614-0 directly accessible by server machine 602-0. Thus, a server process 612-0 may be conceptualized as being coupled, both physically and logically, to its associated files 614-0 and metadata 616-0.

According to the conventional system of FIG. 6, metadata and files may be logically arranged over the entire system (i.e., stored in file server machines) into volumes. In order to determine which volume stores particular files and/or metadata, one or more file server machines (602-0 to 602-n) can store a volume database (618-0 to 618-n). A server process (612-0 to 612-n) can access a volume database (618-0 to 618-n) in the same general fashion as metadata (616-0 to 616-n) or files (614-0 to 614-n), to indicate to a client which particular file server machine(s) has access to a particular volume.

FIG. 6B is a representation of a storage arrangement according to the conventional example of FIG. 6A. Data (including files, metadata, and/or a VLDB) may be stored on volumes. Volumes may include “standard” volumes 620, which can be accessed in response to client requests. In addition, volumes may include replicated volumes 622. Replicated volumes may provide fault tolerance and/or address load imbalance. If one standard volume 620 it not accessible, or is overloaded by accesses, a replicated volume 622 may be accessed in a read-only fashion.

To improve speed, a storage system of FIG. 6A may also include caching of files. Thus, a client process (606-0 to 606-n) may have access to cached files (624-0 to 624-n). Cached files (624-0 to 624-n) may increase performance, as cached files may be accessed faster than files in server machines (602-0 to 602-n).

An approach such as that shown in FIGS. 6A and 6B may have drawbacks related to scalability. In particular, in order to scale up any one particular aspect of the system an entire server machine can be added. However, the addition of such a file server machine may not be the best use of resources. For example, if a file server machine is added to service more requests, its underlying storage may be underutilized. Conversely, if a file server machine is added only for increased storage, the server process may be idle most of the time.

Another drawback to an arrangement such as that shown in FIGS. 6A and 6B can be availability. In the event a file server machine and/or server process fails, the addition of another server may be complicated, as such a server may have to be configured manually by a system administrator. In addition, client machines may all have to be notified of the new server location. Further, the location and volumes of the new server machine may then have to be added to all copies of a VLDB.

It is also noted that maintenance and upgrades can limit the availability of conventional storage system. A change in a server process may have to be implemented to all file server machines. This can force all file server machines to be offline to a time period, or require a number of additional servers (running an old server process) to be added. Unless such additional servers are equal in number/performance to the servers being upgraded, the storage system may suffer in performance.

Flexibility can also be limited in conventional approaches. As previously noted with respect to scalability, changes to a system are essentially monolithic (e.g., the addition of one or more file servers). As system needs vary, only one solution may exist to accommodate such changes: add a file server machine. In addition, as noted with respect to availability, changes in a server process may have to be implemented on all machines simultaneously.

A second conventional example of a storage system approach is shown in FIGS. 7A and 7B.

FIG. 7A is a block diagram of a second conventional storage system. In FIG. 7A, client machines 700-0 to 700-n may be connected to a “virtual” disk 702 by a communication network 704. A virtual disk 702 may comprise a number of disk server machines 702-0 to 702-n. Such an arrangement may also be conceptualized as splitting an interface from metadata and content.

Client machines (700-0 to 700-n) may include client processes (706-0 to 706-n) that can access data on a virtual disk 702 by way of a specialized disk driver 708. A disk driver 708 can be software that allows the storage space of disk server machines (702-0 to 702-n) to be accessed as a single, very large disk.

FIG. 7B shows how data may be stored on a virtual disk. FIG. 7B shows various storage features, and how such features relate to physical storage media (e.g., disk drives). FIG. 7B shows an allocation space 710, which can indicate how the storage space of a virtual disk can be allocated to a particular physical disk drive. A node distribution 712 can show how file system nodes (which can comprise metadata) can be stored on particular physical disk drives. A storage distribution 714 how total virtual disk drive space is actually mapped to physical disk drives. For illustrative purposes only, three physical disk drives are shown in FIG. 7B as 716-0 to 716-2.

As represented by FIG. 7B, a physical disk drive (716-0 to 716-2) may be allocated a particular portion of the total storage space of a virtual disk drive. Such physical disk drives may store particular files and the metadata for such files. That is, metadata can remain physically coupled to its corresponding files.

An approach such as that shown in FIGS. 7A and 7B may have similar drawbacks to the conventional approach of FIGS. 6A and 6B. Namely, a system may be scaled monolithically with the addition of a disk server machine. Availability for a system according to the second conventional example may likewise be limited. Upgrades and/or changes to a disk driver may have to be implemented to all client machines. Still further, flexibility can be limited for the same general reasons as the example of FIGS. 6A and 6B. As system needs vary, only one solution may exist to accommodate such changes: add a disk server machine.

In light of the above, it would be desirable to arrive at an approach to a storage system that may have more scalable components than the described conventional approaches. It would also be desirable to arrive at a storage system that can be more available and/or more flexible than conventional approaches, such as those described above.

### SUMMARY OF THE INVENTION

According to the disclosed embodiments, a storage system may have an interface component, a metadata service component, and a content service component that are composed of physically separate computing machines. An interface component may include gateway servers that map requests from client applications into common operations that can access metadata and files. A metadata service component may include metadata servers that may access metadata according to common operations generated by the interface component. A storage service component may include storage servers that may access files according to common operations generated by the interface component.

According to one aspect of the embodiments, gateway servers, metadata servers, and storage servers may each include corresponding interfaces for communicating with one another over a communication network.

According to another aspect of the embodiments, a component (interface, metadata service, or content service) may include servers having different configurations (e.g., having different hardware and/or software) allowing resources to be optimally allocated to particular client applications.

According to another aspect of the embodiments, a component (interface, metadata service, or content service) may include a number of computing machines. The hardware and/or software on one computing machine may be upgraded/replaced/serviced while the remaining computing machines of the component remain operational.

### BRIEF DESCRIPTION OF THE DRAWINGS

FIG. 1 is a block diagram of a storage system according to a first embodiment.

FIGS. 2A to 2C are block diagrams of various servers according to one embodiment.

FIG. 3 is a block diagram of a storage system according to a second embodiment.

FIGS. 4A to 4C are block diagrams showing how server resources may be altered according to one embodiment.

FIGS. 5A and 5B are block diagrams showing the scaling of a storage system according to one embodiment.

FIGS. 6A and 6B show a first conventional storage system.

FIGS. 7A and 7B show a second conventional storage system.

### DETAILED DESCRIPTION OF THE EMBODIMENTS

Various embodiments of the present invention will now be described in conjunction with a number of diagrams. The various embodiments include a storage system that may include improved scalability, availability and flexibility. Such a storage system according to the present invention may include an interface component, metadata component, and content component that are physically separate from one another.

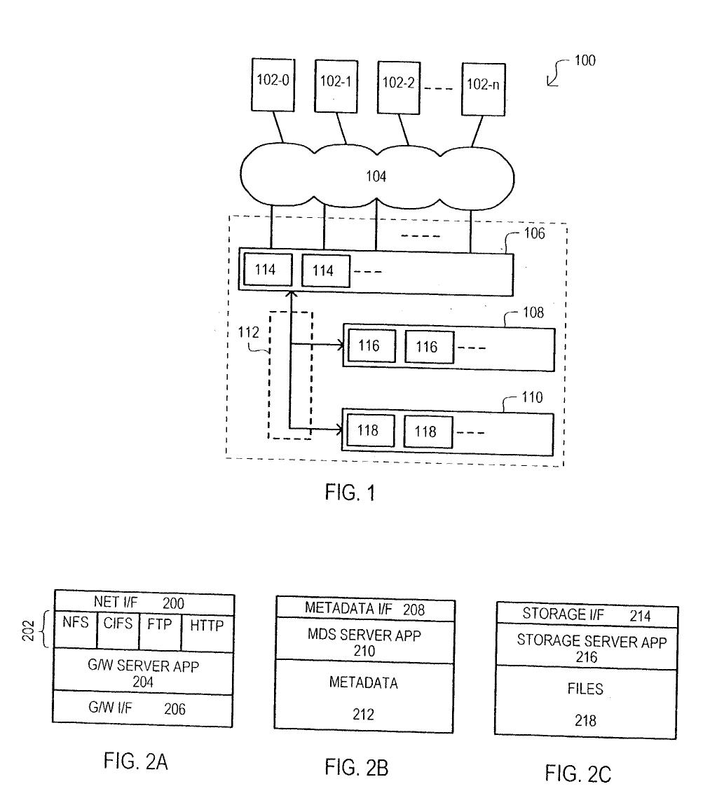

Referring now to FIG. 1, a storage system according to a first embodiment is shown in a block diagram and designated by the general reference character 100. A storage system 100 may communicate with one or more client machines 102-0 to 102-n by way of a communication network 104. In this way, client machines (102-0 to 102-n) may make requests to a storage system 100 to access content and/or metadata stored therein.

A storage system 100 may include three, physically separate components: an interface 106, a metadata service 108 and a content service 110. Such components (106, 108 and 110) may be physically separated from one another in that each may include one or more computing machines dedicated to performing tasks related to a particular component and not any other components. The various components (106, 108 and 110) may be connected to one another by way of a network backplane 112, which may comprise a communication network.

An interface 106 may include a number of gateway servers 114. Gateway servers 114 may communicate with client machines (102-0 to 102-n) by way of communication network 104. File or metadata access requests generated by a client machine (102-0 to 102-n) may be transmitted over communication network 104 and received by interface 106. Within interface 106, computing machines, referred to herein as gateway servers 114, may process such requests by accessing a metadata service 108 and/or a content service 110 on behalf of a client request. In this way, accesses to a file system 100 may occur by way of an interface 106 that includes computing machines that are separate from those of a metadata service 108 and/or a storage service 110.

Within a metadata service 108, computing machines, referred to herein as metadata servers 116, may process accesses to metadata generated from an interface 106. A metadata service 108 may store metadata for files contained in the storage system 100. Metadata servers 116 may access such metadata. Communications between metadata servers 116 and gateway servers 114 may occur over a network backplane 112. In this way, accesses to metadata may occur by way of a metadata service 108 that includes computing machines that are separate from those of an interface 106 and/or a storage service 110.

Within a storage service 110, computing machines, referred to herein as storage servers 118, may process accesses to files generated from an interface 106. A storage service 110 may store files contained in the storage system 100. Storage servers 118 may access stored files within a storage system 100. Communications between storage servers 118 and gateway servers 114 may occur over a network backplane 112. In this way, accesses to stored files may occur by way of a storage service 108 that includes computing machines that are separate from those of an interface 106 and/or a metadata service 108.

Thus, a storage system 100 may include metadata that can reside in a metadata service 108 separate from content residing in a storage service 110. This is in contrast to conventional approaches that may include file servers that contain files along with corresponding metadata.

Referring now to FIGS. 2A to 2C, examples of a gateway server 114, a metadata server 116 and a storage server 118 are shown in block diagrams.

Referring now to FIG. 2A, a gateway server is shown to include a network interface 200, a mapping layer 202, a gateway server application 204 and a gateway interface 206. A network interface 200 may include software and hardware for interfacing with a communication network. Such a network interface 200 may include various network processing layers for communicating over a network with client machines. As but one of the many possible examples, a network interface 200 may include a physical layer, data link layer, network layer, and transport layer, as is well understood in the art.

A mapping layer 202 can allow a gateway server to translate various higher level protocols into a set of common operations. FIG. 2A shows four particular protocols including a Network Files System (NFS) protocol, a Common Internet File System (CIFS) protocol, a File Transfer Protocol (FTP) and Hypertext Transfer Protocol (HTTP). However, such particular cases should not be construed as limiting to the invention. Fewer or greater numbers of protocols may be translated, and/or entirely different protocols may be translated.

As but one possible example, various higher level protocols may be translated into common operations such as lookup, read, new, write, and delete. Lookup operations may include accessing file system metadata, including directory structures, or the like. Thus, such an operation may include a gateway server accessing one or more metadata servers. Read and write operations may include reading from or writing to a file stored in a storage system. Thus, such operations may include accessing one or more storage servers. A new operation may include creating a new file in a storage system. Such an operation may include an access to a storage server to create a location for a new file, as well as an access to a metadata server to place the new file in a file system, or the like. A delete operation may include removing a file from a system. Such an operation may include accessing a metadata server to remove such a file from a file system. In addition, a storage server may be accessed to delete the file from a storage service.

Referring again to FIG. 2A, a gateway server application 204 may include one or more processes for controlling access to a storage system. For example, a gateway server application 204 may execute common operations provided a mapping layer 202. A gateway interface 206 may enable a gateway server to interact with the various other components of a storage system. A gateway interface 206 may include arguments and variables that may define what functions to be executed by gateway server application 204.

Referring now to FIG. 2B, a metadata server according to one embodiment may include a metadata server interface 208, a metadata server application 210 and metadata 212. A metadata server interface 208 may include arguments and variables that may define what particular functions are executed by a metadata server application 210. As but one example, a lookup operation generated by a gateway server may be received by a metadata server application 210. According to information provided by a gateway server, a metadata server interface 208 may define a particular directory to be accessed and a number of files to be listed. A metadata server application 210 may execute such requests and return values (e.g., a list of filenames with corresponding metadata) according to a metadata server interface 208. Thus, according to one arrangement, a metadata server application 210 may access storage media dedicated to storing metadata and not the files corresponding to the metadata.

Metadata 212 may include data, excluding actual files, utilized in a storage system. As but a few examples, metadata 212 may include file system nodes that include information on particular files stored in a system. Details on metadata and particular metadata server approaches are further disclosed in commonly-owned co-pending patent application titled STORAGE SYSTEM HAVING PARTITIONED MIGRATABLE METADATA by Kacper Nowicki, filed on Sep. 11, 2000 (referred to herein as Nowicki). The contents of this application are incorporated by reference herein.

While a metadata server may typically store only metadata, in some cases, due to file size and/or convenience, a file may be clustered with its corresponding data in a metadata server. In one approach, files less than or equal to 512 bytes may be stored with corresponding metadata, more particularly files less than or equal to 256 bytes, even more particularly files less than or equal to 128 bytes.

Referring now to FIG. 2C, a storage server according to one embodiment may include a storage server interlace 214, a storage server application 216 and files 218. A storage server interface 214 may include arguments and variables that may define what particular functions are executed by a storage server application 216. As but one example, a particular operation (e.g., read, write) may be received by a storage server interface 210. A storage server application 216 may execute such requests and return values according to a storage server interface 214.

In this way, interfaces 206, 208 and 214 can define communications between servers of physically separate storage system components (such an interface, metadata service and content service).

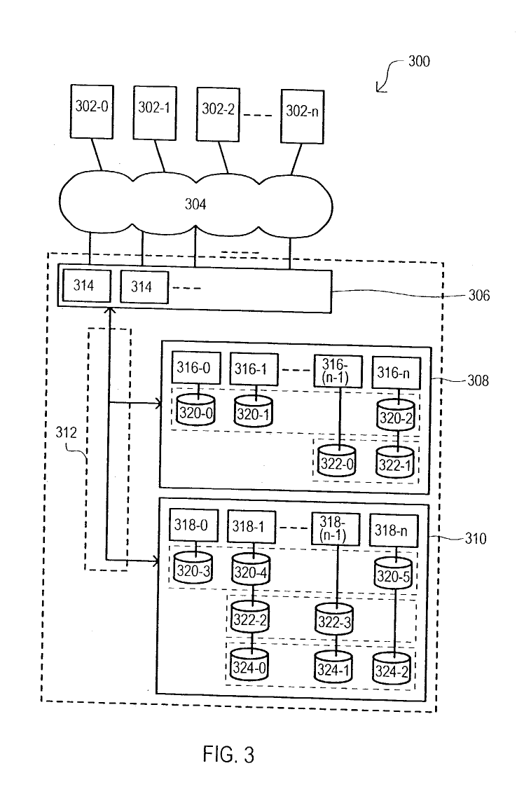

Various embodiments have been illustrated that show how storage service functions can be distributed into at least three physically separate components. To better understand additional features and functions, more detailed embodiments and operations will now be described with reference to FIG. 3.

FIG. 3 is a block diagram of a second embodiment of a storage system. A second embodiment is designated by the general reference 300, and may include some of the same constituents as the embodiment of FIG. 1. To that extent, like portions will be referred to by the same reference character but with the first digit being a “3” instead of a “1.”

FIG. 3 shows how a storage system 300 according to a second embodiment may include servers that are tuned for different applications. More particularly, FIG. 3 shows metadata servers 316-0 to 316-n and/or storage servers 318-0 to 318-n may have different configurations. In the example of FIG. 3, metadata servers (316-0 to 316-n) may access storage hardware of two different classes. A class may indicate one or more particular features of storage hardware, including access speed storage size, fault tolerance, data format, to name but a few.

Metadata servers 316-0, 316-1 and 316-n are shown to access first class storage hardware 320-0 to 320-2, while metadata servers 316-(n-1) and 316-n are shown to access second class storage hardware 322-0 and 322-1. Of course, while FIG. 3 shows a metadata service 308 with two particular classes of storage hardware, a larger or smaller number of classes may be included in a metadata service 308.

Such an arrangement can allow resources to be optimized to particular client application. As but one example, first class storage hardware (320-0 to 320-2) may provide rapid access times, while second class storage hardware (322-0 and 322-1) may provide less rapid access times, but greater storage capability. Accordingly, if a client application had a need to access a file directory frequently and/or rapidly, such a file directory could be present on metadata server 316-0. In contrast, if an application had a large directory structure that was not expected to be accessed frequently, such a directory could be present on metadata server 316-(n-1). Still further, a metadata server 316-n could provide both classes of storage hardware. Such an arrangement may also allow for the migration of metadata based on predetermined policies. More discussion of metadata migration is disclosed in Nowicki.

In this way, a physically separate metadata service can allow non-uniform components (e.g., servers) to be deployed based on application need, adding to the flexibility and availability of the overall storage system.

FIG. 3 also illustrates how storage servers (318-0 to 318-n) may access storage hardware of various classes. As in the case of a metadata service 308, different classes may indicate one or more particular features of storage hardware. Storage servers 318-0, 318-1 and 318-n are shown to access first class storage hardware 320-3 to 320-5, storage servers 318-1 and 318-(n-1) are shown to access second class storage hardware 322-2 and 322-3, and storage servers 318-1, 318-(n-1) and 318-n are shown to access third class storage hardware 324-0 to 324-2. Of course, more or less than three classes of storage hardware may be accessible by storage servers (318-0 to 318-n).

Further, classes of metadata storage hardware can be entirely different than classes of file storage hardware.

Also like a metadata storage service 308, resources in a content service 310 can be optimized to particular client applications. Further, files stored in a content service 310 may also be migratable. That is, according to predetermined policies (last access time, etc.) a file may be moved from one storage media to another.

In this way, a physically separate storage service can also allow non-uniform components (e.g., servers) to be deployed based on application need, adding to the flexibility and availability of the overall storage system.

It is understood that while the FIG. 3 has described variations in one particular system resource (i.e., storage hardware), other system resources may vary to allow for a more available and flexible storage system. As but one example, server processes may vary within a particular component.

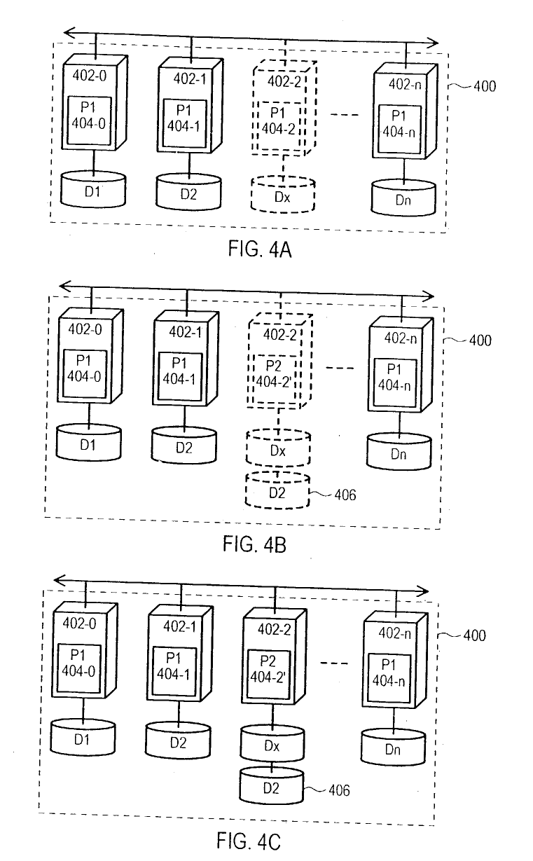

The separation (de-coupling) of storage system components can allow for increased availability in the event system processes and/or hardware are changed (to upgrade, for example). Examples of changes in process and/or hardware may best be understood with reference to FIGS. 4A to 4C.

FIGS. 4A to 4C show a physically separate system component 400, such as an interface, metadata service or content service. A system component 400 may include various host machines 402-0 to 402-n running particular server processes 404-0 to 404-n. In FIG. 4A it will be assumed that the various server processes (404-0 to 404-n) are of a particular type (PI) that is to be upgraded.

Server process 404-2 on host machine 402-2 may be disabled. This may include terminating such a server process and/or may include turning off host machine 402-2. Prior to such a disabling of a server process 404-2, the load of a system component 400 can be redistributed to make server process 404-2 redundant.

As shown in FIG. 4B, a new server process 404-2′ can be installed onto host machine 402-2.

In FIG. 4C, the load of a system component 400 can then be redistributed again, allowing new server process 404-2′ to service various requests. It is noted that such an approach may enable a system component 400 to be widely available even as server processes are changed.

Of course, while FIGS. 4A-4C have described a method by which one type of resource (i.e., a server process) may be changed, the same general approach may be used to change other resources such as system hardware. One such approach is shown by the addition of new hardware 406 to host machine 402-2.

For example, it can also be assumed in FIGS. 4B and 4C that host machine 402-1 will be taken off line (made unavailable) for any of a number of reasons. It is desirable, however, that the data accessed by host machine 402-1 continues to be available. Thus, as shown in FIG. 4B, data D2 may be copied from host machine 402-1 to storage in host machine 402-2. Subsequently, host machine 402-2 may be brought online as shown in FIG. 4C. Host machine 402-1 may then be taken offline once more.

It is understood that while FIG. 4B shows data D2 on a new hardware 406, such data D2-could have been transferred to existing storage hardware provided enough room was available.

In this way, data accessed by one server (or host machine) can continue to be made available while the server (or host machine) is not available.

Still further, the same general approach shown in FIGS. 4A to 4C can be used to meet growing needs of a system. As the load on a particular component grows, resources may be added to such a component. This is in contrast to conventional approaches to monolithically add a server with more than one storage system component to meet changing needs. As but a few of the many possible examples, in the event traffic to a storage system rises, additional gateway servers may be added to an interface. Likewise, as metadata grows in size additional metadata storage equipment with or without additional metadata servers may be added. Metadata servers may also be added in the event metadata accesses increase to allow more rapid/frequent accesses to metadata. Similarly, increases in content size can be met with additions of storage equipment to existing storage servers and/or the addition of new storage servers with corresponding storage equipment. Like the metadata service case, if more content accesses occur, additional storage servers can be added to meet such increases in activity.

Of course, it is understood that in some arrangements, more than one server process may run on a host machine. In such cases, additional server processes may be activated on such host machines, which can further add to storage system scalability, availability and flexibility.

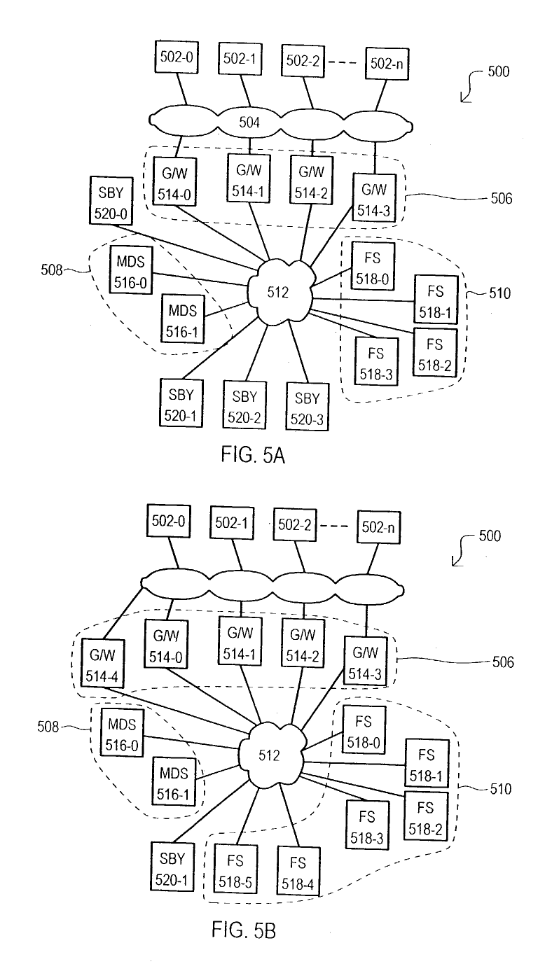

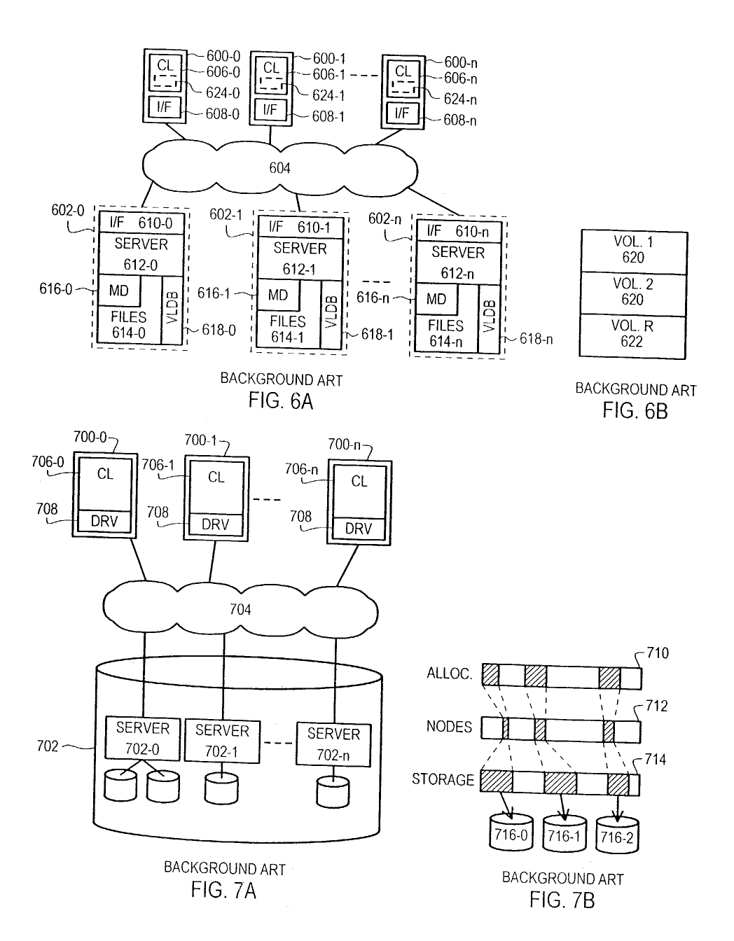

FIGS. 5A and 5B show how a storage system may be scaled to meet increasing demands. FIGS. 5A and 5B show a storage system designated by the general reference 500. A storage system may include some of the same constituents as the embodiment of FIG. 1. To that extent, like portions will be referred to by the same reference character but with the first digit being a “5” instead of a “1.”

In FIG. 5A, an interface 506 may include gateway servers 514-0 to 514-3, a metadata service 508 may include metadata servers 516-0 and 516-1, and a content service 510 may include storage servers 518-0 to 518-3.

A storage system 500 according to FIG. 5A may further include standby servers 520-0 to 520-3. Standby servers (520-0 to 520-3) may represent one or more servers that have been included in anticipation of increased resource needs. In addition or alternatively, standby servers may represent servers that have been added to a storage system 500 in response to increased resource needs.

FIG. 5B illustrates how standby servers may be activated (and thereby added) to individual storage system components (506, 508, 510) to meet increased system needs. In particular, standby server 520-0 of FIG. 5A has been activated as a gateway server 514-4 and standby servers 520-2 and 520-3 have been activated as storage servers 518-4 and 514-4. The activation of a standby server to a particular server type may include having a standby server that has been pre-configured as a particular server type.

For example, in FIGS. 5A and 5B, standby server 520-3 may have been previously included a storage server process and have access to appropriate storage equipment. Alternatively, the activation of a standby server may include installing appropriate server software and/or adding additional hardware to an existing or new host machine.

As but another example standby server 520-0 may have already included the hardware and software to connect to communication network 504. In addition or alternatively, such hardware and software may be added to create a host machine that is suitable to function as a gateway server.

In this way, any or all of the components (506, 508 and 510) may be scaled to meet changing demands on a storage system 500.

It is thus understood that while the various embodiments set forth herein have been described in detail, the present invention could be subject various changes, substitutions, and alterations without departing from the spirit and scope of the invention. Accordingly, the present invention is intended to be limited only as defined by the appended claims.

What is claimed is:

1. A storage system, comprising:
an interface component that includes a plurality of first computing machines operating as gateway servers, each gateway server receiving storage system access requests from client applications;
a metadata service component that stores metadata for files stored in the storage system, the metadata service component including a plurality of second computing machines operating as metadata servers, the second computing machines being separate from the first computing machines, each metadata server receiving metadata access requests from the interface component; and
a content component that stores files for the storage system, the content component including a plurality of third computing machines operating as storage servers, the third computing machines being separate from the first and second computing machines, each storage server receiving file access requests from the interface component.

2. The storage system of claim 1, wherein:
each gateway server includes
a network interface for processing requests from client applications,
a mapping layer for translating client application requests into a common set of file and metadata access operations,
a gateway application for executing the common set of operations in conjunction with the metadata service component and content component, and
a gateway interface that defines operations for the metadata service component and content component.

3. The storage system of claim 1, wherein:
each metadata server includes
a metadata server interface for receiving defined operations from the interface component, and
a metadata server application for executing defined operations and returning values to the interface component; wherein
each metadata server can store metadata for a predetermined number of files stored in the content component.

4. The storage system of claim 1, wherein:
each storage server includes
a storage server interface for receiving defined operations from the interface component, and
a storage server application for executing defined operations and returning values to the interface component; wherein
each storage server can store metadata for a predetermined number of files.

5. The storage system of claim 1, wherein:
the interface component can receive storage system access requests over a first network; and
the interface component, metadata service component, and content component are commonly connected by a second network.

6. The storage system of claim 1, wherein:
the metadata service component includes metadata servers that access different types of storage hardware.

7. The storage system of claim 1, wherein:
the storage service component includes storage servers that access different types of storage hardware.

8. A storage system, comprising:
first computing machines configured to service accesses to stored files and not configured to access metadata for the stored files; and
second computing machines configured to service accesses to metadata for the stored files.

9. The storage system of claim 8, wherein:
the first computing machines are physically connected to file storage equipment that stores the stored files; and
the second computing machines are physically connected to metadata storage equipment that stores metadata for the stored files.

10. The storage system of claim 8, further including:
third computing machines configured to service requests to the storage system from client applications by accessing the first and second computing machines.

11. The storage system of claim 10, wherein:
the first, second and third computing machines are connected to on another by a communication network.

12. The storage system of claim 10, wherein:
each first computing machine may include at least one storage server process that may receive access requests from a requesting third computing machine and return stored file data to the requesting third computing machine.

13. The storage system of claim 10, wherein:
each second computing machine may include at least one metadata server process that may receive access requests from a requesting third computing machine and return metadata to the requesting third computing machine.

14. The storage system of claim 8, wherein:
each second computing machine stores files no greater than 512 bytes in size.

15. A method of operating a storage system, comprising the steps of:
storing files on a first set of machines;
storing metadata for the files on a second set of machines; and
receiving requests for metadata and files on a third set of machines; wherein
the first, second and third machines are physically separate but connected to one another by a communication network.

16. The method of claim 15, further including:
accessing files stored on the first set of machines through the third set of machines.

17. The method of claim 16, wherein:
accessing files includes the third set of machines mapping requests into common file access operations that are executable by the first set of machines.

18. The method of claim 154, further including:
accessing metadata stored on the second set of machines through the third set of machines.

19. The method of claim 18, wherein:
accessing metadata includes the third set of machines mapping requests into common metadata access operations that are executable by the second set of machines.

20. The method of claim 15, further including:
running storage server processes on a plurality of first computing machines; and
changing the storage server process on at least one of the first computing machines while the storage server processes continue to run on the remaining first computing machines.

21. The method of claim 15, further including:
each first machine being connected to corresponding storage equipment that stores files; and
altering the storage equipment on at least one of the first computing machines while the remaining first computing machines are able to access files on corresponding storage equipment.

22. The method of claim 15, further including:
running metadata server processes on a plurality of second computing machines; and
changing the metadata server process on at least one of the second computing machines while the metadata server processes continue to run on the remaining second computing machines.

23. The method of claim 15, further including:
each second machine being connected to corresponding storage equipment that stores metadata; and
altering the storage equipment on at least one of the second computing machines while the remaining second computing machines are able to access metadata on corresponding storage equipment.
